(19) United States
(12) Patent Application Publication
(10) Pub. No.: US 2012/0261498 A1
(43) Pub. Date: Oct. 18, 2012

(54) SPRINKLER HEAD

(76) Inventors: Hirotaka Kameishi, Tokyo (JP); Masashi Murakami, Tokyo (JP)

(21) Appl. No.: 13/516,854

(22) PCT Filed: Dec. 27, 2010
(86) PCT No.: PCT/JP2010/073591

§ 371 Date: Jun. 25, 2012

(30) Foreign Application Priority Data
Dec. 28, 2009 (JP) 2009-298324
Jan. 27, 2010 (JP) 2010-015945
Jan. 28, 2010 (JP) 2010-016548
Oct. 21, 2010 (JP) 2010-236744

(51) Int. Cl. B05B 1/30

(52) U.S. Cl. 239/583

(57) ABSTRACT

A sprinkler head having a strong impact structure (impact resistance structure) is provided. A head body 10 having a water discharging port 12, a valve body 30 to be brought into press contact with a valve seat 17 formed at a lower end of the water discharging port 12, and a valve body supporting mechanism 50 configured to support the valve body 30 are provided. The valve body supporting mechanism 50 includes a cylindrical plunger 52 having a flange portion 52a at a lower portion thereof, a thermosensitive member 55 provided at the flange portion 52a of the plunger 52, and a thermosensitive plate 53 coming into contact with the thermosensitive member 55 and provided so as to be orthogonal to an axial center of the head body 10. The plunger 52 is provided so that a lower end portion thereof projects downward with respect to the thermosensitive plate 53.

### TECHNICAL FIELD

The present invention relates to a sprinkler head and, more specifically, to a sprinkler head having a structure resistant to an impact (impact resistance structure).

### BACKGROUND ART

As the sprinkler head of the related art, for example, “A sprinkler head comprising water stop means, locking means having a balancer, and thermosensitive means, the balancer is formed with a projecting edge having an outer diameter larger than the inner diameter of an inwardly projecting edge at a lower end portion of a frame for storing the water stop means and the locking means, so that the balancer is prevented from being depressed into the frame even when an impact is applied to the thermosensitive means on the outside thereof . . . ” is proposed (for example, see Patent Literature 1).

The locking means includes balls locked with the locking shoulder of the frame, a slider configured to press the ball from above, and the balancer configured to inhibit the inward movement of the balls.

With this sprinkler head, when thermosensitive member such as solder is melted, the locking state between the balls and the locking shoulder portion is released, and the valve body drops down to allow water to be discharged. However, when the valve body moves away from the valve seat, there arises a risk of becoming inoperative due to the leakage during the operation, and hence the valve body is configured not to move away from the valve seat.

In the sprinkler head configured as described above, in order to prevent the valve body from moving away from the valve seat until the locked state between the balls and the locking shoulder portion is completely released, a large coil spring having a large amount of displacement is provided in a lower portion of the valve body or an O-ring is provided on an outer periphery of the valve body, so that the leakage of water which may occur when starting the operation is prevented.

Also, in a flash type sprinkler head of the related art, a sprinkling portion includes a deflector, a guide rod, and a stopper ring. Normally, the stopper ring is fixed to an upper end of the guide rod, and the deflector is fixed to a lower end of the guide rod, so that the sprinkling portion is integrated. For reference sake, there is also another type of the sprinkling portion configured to slide a deflector itself downward (drop down) from an upper end to a lower end of the guide rod) at the time of water discharge.

The stopper ring is provided at an upper end of the frame which constitutes the sprinkler head and is configured to drop down to a locking shoulder portion provided at a lower end on the inner periphery of the frame at the time of water discharging operation. In other words, the stopper ring is locked with the locking shoulder portion of the frame and supports the deflector via the guide rod, whereby water discharge is performed (see Patent Literature 1).

### CITATION LIST

### Patent Literature

PTL 1: Japanese Unexamined Patent Application Publication No. 10-179789 (Claims, FIG. 1)

### SUMMARY OF INVENTION

### Problems to be Solved by the Invention

In the sprinkler head of the related art, a thermosensitive plate is provided at a lowermost end of the sprinkler head. Therefore, when something hits against the sprinkler head, it comes into abutment with the thermosensitive plate. The thermosensitive plate, being formed of a thin metallic plate and being of lesser strength, is subjected to deformation when an external force is applied thereto, so that an event that the plunger digs into the thermosensitive plate may arise. The thermosensitive plate is configured to be operated by melting of solder or the like. However, there is a problem such that if the thermosensitive plate is coupled with the plunger, an operation failure such as closing of a gap for allowing the solder or the like to flow out or hindrance of a downward movement of the thermosensitive plate may occur. From these reasons, development of a sprinkler head having a structure resistant to an impact has been desired.

There is also a problem in using the coil spring having a large amount of displacement as described above such that downsizing of the sprinkler head is impaired, and the O-ring used for the valve body have a probability of adherence, and hence the reliability of the operation of the sprinkler head is lowered.

Furthermore, in the sprinkler head, the sprinkling portion is moved at the time of water discharging operation. The smaller the amount of movement, the more the action is stabilized. However, in the sprinkler head of the related art, the stopper ring is moved from the upper end to the lower end of the frame and hence the amount of movement at the time of operation is large.

There is a sprinkler head having a coil spring provided above the stopper ring in order to ensure the downward sliding movement of the stopper ring. However, there is a problem, in this case, in that the height of the sprinkler head is inevitably increased.

There is also a configuration in which the downward sliding movement of the sprinkling portion is further ensured by the guiding member. However, there is a problem in that the guide member may hinder the sprinkling at the time of water discharge.

In order to solve the above-described problem, it is an object of the present invention to provide a sprinkler head having a structure resistant to an impact.

Also, in order to solve the above-described problem, it is an object of the present invention to provide a sprinkler head which allows reduction in size, and is high in reliability of operation.

Also, in order to solve the above-described problem, it is an object of the present invention to provide a sprinkler head having high reliability in downward movement of the stopper ring of the sprinkling portion.

### Solution to Problem

A sprinkler head according to the present invention is a sprinkler head including: a cylindrical head body having a water discharging port; a valve body configured to close the water discharging port; and a valve body supporting mechanism configured to support the valve body, the valve body supporting mechanism including a plunger having a flange portion at a lower portion thereof; a thermosensitive member provided on the flange portion of the plunger; and a thermosensitive plate provided in contact with the thermosensitive member, characterized in that an end of the plunger on the side of the thermosensitive plate protrudes with respect to the thermosensitive plate in the direction of an axial center of the head body.

In the sprinkler head of the present invention, the end portion of the plunger on the side of the thermosensitive plate projects with respect to the thermosensitive plate in the direction of the axial center of the head body. Therefore, even when an event such that something abut against the sprinkler head, the something comes into abutment with the plunger and, since the plunger has a high rigidity, there is no probability of deformation. Therefore, the plunger is prevented from digging into the thermosensitive plate, occurrence of the operation failure is avoided, so that a sprinkler head having a structure resistant against the impact is realized.

The present invention is characterized in that the thermosensitive plate includes a protruded portion configured to cover the thermosensitive member, and a disk portion formed by causing one end side of the protruded portion to protrude outward with respect to the axial center, and the plunger has a shoulder or a tapered surface or an R surface at an outer peripheral edge of the flange portion protruded from thermosensitive plate, and the outer peripheral edge of the flange portion is arranged so as to be inscribed in the protruded portion of the thermosensitive plate via a gap.

Since the sprinkler head of the present invention includes a shoulder, a tapered surface or a R surface on the flange of the plunger, only the shoulder or the tapered surface is crushed, and hence the gap formed between the flange portion and the thermosensitive plate is prevented from being closed, so that the occurrence of the operation failure of the sprinkler head at the time of water discharge operation is avoided.

The present invention is characterized in that a side wall portion protruded toward the head body is provided on an outer periphery of the disk portion of the thermosensitive plate.

In the sprinkler head of the present invention, with the provision of the side wall portion, even when an impact is applied from the outside, the impact can be absorbed by the deformation of the side wall portion. Therefore, deformation of the member such as the plunger or the like which is subjected to a resolution displacement at the time of water discharge operation can be prevented.

The present invention is characterized in that the side wall portion is provided with a hole.

In the sprinkler head of the present invention, a heat conducting path which allows the hot air to flow into the inside of the thermosensitive plate from the hole on the side wall portion and transfer heat to the protruded portion of the thermosensitive plate which is in contact with the thermosensitive member, whereby melting of the thermosensitive member may be accelerated. Also, by forming the hole on the side wall portion, the thermosensitive plate is subjected to deformation when applied with an impact from the outside, whereby the impact can be absorbed. Therefore, deformation of the components such as the plunger or the like which are subjected to a resolution displacement at the time of water discharge operation or the deformation of the components which may results in mutual coupling can be prevented. One or more of such holes may be provided on the side wall portion.

The present invention includes a disk member coming into contact with a bottom surface of the protruded portion of the thermosensitive plate, and the disk member is arranged at the same height as the hole on the side wall portion.

In the sprinkler head of the present invention, a heat conducting path which causes the hot air to flow into the inside of the thermosensitive plate from the hole on the side wall portion to cause the disk member to absorb the heat, and transfer the heat to the protruded portion of the thermosensitive plate which is in contact with the thermosensitive member from the disk member.

The present invention is characterized in that the valve body supporting mechanism includes a set screw configured to couple with the plunger between the valve body and the plunger, the plunger includes a peripheral wall portion having a hole in the interior thereof, and the peripheral wall portion includes a thinned portion having a difference between the inner diameter and the outer diameter smaller than that of a joint portion with respect to the set screw is provided at a contact portion with respect to the thermosensitive member provided on the flange portion.

In the sprinkler head according to the present invention, the cross-sectional area of the peripheral wall portion of the contact portion of the plunger with respect to the thermosensitive member is smaller than that of the joint portion thereof with respect to the set screw. Accordingly, heat can hardly escape to the joint portion at which the heat conduction resistance is larger than the contact portion with respect to the thermosensitive member, so that the melting of the thermosensitive member at the contact portion may be accelerated.

The present invention is characterized in that a heat insulating member is arranged in the hole of the plunger.

In the sprinkler head of the present invention, by the arrangement of the heat-insulating member, the sensitivity performance can be improved. Also, by installing the heat-insulating member inside the contact portion with respect to the thermosensitive member, the plunger can be reinforced, so that the improvement of the impact resistant performance is achieved. As the heat insulating member, for example, the one formed of resin may be used.

The present invention is characterized in that the heat insulating member has a projecting portion projecting from an end surface of the plunger.

In the sprinkler head according to the present invention, by configuring in such a manner that when an impact is applied from the outside, the impact is applied to hit against the heat insulating member, so that the deformation of the thermosensitive plate can be inhibited. Therefore, deformation of the member such as the plunger or the like which is subjected to a resolution displacement at the time of water discharge operation can be prevented.

The present invention includes a frame connected at one end to the head body and having at the other end a locking shoulder portion protruding inward, a ball configured to be locked with the locking shoulder portion, a slider configured to press the ball from the opposite side of the locking shoulder portion and support the valve body, and a balancer provided inside of the ball and configured to inhibit the movement of the ball, wherein an outer peripheral edge of the slider is formed into an inwardly inclining tapered shape, and an inclined surface in a tapered shape is a contact surface with respect to the ball.

Since the amount of movement (the amount of downward movement) of the slider in the axial direction when the ball enters inside the slider and climbs over the balancer, and the locking with respect to the frame locking shoulder portion is released is smaller than that in the case where the inside of the slider is flat, so that the leakage can hardly occur during the operation. Also, since the amount of movement of the slider is small, the coil spring having a large amount of displacement does not have to be used, and leakage of water during the operation can be prevented sufficiently with a spring having a small amount of displacement such as a disk spring.

The present invention includes a frame connected at one end to the head body and having at the other end a locking shoulder portion protruding inward, a ball configured to be locked with the locking shoulder portion, a slider configured to press the ball from the opposite side of the locking shoulder portion and support the valve body, and a balancer provided inside of the ball and configured to inhibit the movement of the ball, and is characterized in that the slider is formed with a contact surface for the ball on the outer peripheral edge of the slider, and a recessed portion for the ball formed with a depression inside the contact surface with respect to the balls.

In the sprinkler head of the present invention, at the time of operation of the sprinkler head, when the ball enters the inner peripheral side of the slider, the ball moves so as to enter the recessed portion, and hence the ball accelerates the operation of the ball to move away from the locking shoulder portion, whereby the amount of movement of the ball is reduced, thereby reducing the operation stroke.

The present invention is characterized in that the balancer is formed with a hole for inserting a peripheral wall portion of the plunger, and the plunger is inserted into the balancer at an outer peripheral surface thereof and coupled with the set screw on an inner peripheral surface thereof at one end side of the peripheral wall portion thereof.

In the sprinkler head of the present invention, the balancer is formed with a hole for inserting a peripheral wall portion of the plunger, and the plunger is inserted into the hole of a balancer at an outer peripheral surface thereof and coupled with the set screw on an inner peripheral surface thereof at one end side of the peripheral wall portion thereof. Therefore, the rigidity is enhanced, so that even when the external force is applied, there is no risk of deformation of the plunger, whereby the occurrence of the operation failure is avoided.

The present invention is characterized in that the head body is formed with a water discharging cylinder having a water discharging port, and a frame connected at one end to the head body and having at the other end a locking shoulder portion protruding inward, a sprinkling portion having a deflector, a guide rod configured to guide the movement of the deflector, and a stopper ring configured to stop the movement of the guide rod is further provided, the stopper ring is provided with an insertion hole for the guide rod and the guide rod is formed with a shoulder for the stopper larger than the insertion hole, and the stopper ring moves in the interior of the frame, comes into abutment with the locking shoulder portion and stops at the time of water discharging operation.

In the sprinkler head of the present invention since the stopper ring is formed with an insertion hole which allows the guide rod to be inserted therethrough, first of all, the deflector provided with the valve body is moved downward with the guide rod at the time of water discharge operation and subsequently, the stopper ring is pressed down by the coil spring and hence is moved downward.

In the normal state, the deflector is provided under the water discharging cylinder of the head body, and is provided with a stopper ring on the deflector. Therefore, at the time of water discharging cylinder, the stopper ring moves only from a portion around the lower end of the water discharging cylinder to the locking shoulder portion at the lower end of the frame. Therefore, since the amount of movement of the stopper ring by itself is reduced, the action of at the time of operation is stabilized.

The present invention is characterized in that the stopper ring is provided with a guide member which causes the stopper ring to move along the water discharging cylinder.

In the sprinkler head of the present invention, since the guide member bent upward is provided on the inner peripheral side of the stopper ring, the stopper ring is moved downward by being guided by the guide member, the action is stabilized. In particular, the guide member, being bent upward, is prevented from becoming an obstacle for sprinkling at the time of water discharge.

The present invention is characterized in that the stopper ring is provided at substantially an intermediate position of the frame in the height direction, and a coil spring configured to urge the stopper ring toward the locking shoulder portion of the frame between the stopper ring and the head body.

In the sprinkler head of the present invention, since the coil spring which presses the stopper ring downward is installed between the outer peripheral portion of the stopper ring and the lower portion of the outer peripheral portion of the head portion, the coil spring can be provided in the interior of the sprinkler head by utilizing a dead space, so that reduction in size of the sprinkler head can easily be achieved.

The present invention is characterized in that the deflector is fixed to one end side of the guide rod, the head body is formed with an outer peripheral wall portion configured to be coupled with the frame, the outside of the water discharging cylinder and the other end side of the guide rod fixed at one end side to the deflector is stored in a space formed between the water discharging cylinder and the outer peripheral wall portion.

In the sprinkler head of the present invention, the deflector is fixed to the lower end of the guide rod and, in the normal state, the guide rod is stored in a space formed between the inner peripheral portion of the head body and the water discharging cylinder. In other words, in the space, the stopper ring is not installed as in the related art, and only the thin guide rod is installed, so that the space between the inner peripheral portion of the head body and the water discharging cylinder can be reduced.

### Advantageous Effects of Invention

According to the sprinkler head of the invention, since the end portion of the plunger on the side of the thermosensitive plate protrudes with respect to the thermosensitive plate in the direction of the axial center of the head body, even when there arises an event such that something hits against the sprinkler head, occurrence of the operation failure is avoided, and a sprinkler head having a structure resistant to the impact may be realized.

### BRIEF DESCRIPTION OF DRAWINGS

FIG. 1 is a vertical cross-sectional view of a sprinkler head according to a first embodiment of the present invention.

FIG. 2 illustrates cross-sectional views showing a state of operation of the sprinkler head shown in FIG. 1.

FIG. 3 is a cross-sectional view showing a plunger in FIG. 1 in detail.

FIG. 4 is a cross-sectional view showing a (first) modification of the plunger.

FIG. 5 illustrates cross-sectional views showing a (second) modification of the plunger.

FIG. 6 is a cross-sectional view showing a (third) modification of the plunger.

FIG. 7 is a cross-sectional view showing a (first) modification of a slider.

FIG. 8 is a cross-sectional view showing a (second) modification of the slider.

FIG. 9 shows a plan view, a front view, a side view, a perspective view, and a cross-sectional view taken along the line E-E of a disk spring shown in FIG. 1.

FIG. 10 illustrates perspective views of a stopper ring.

FIG. 11 is a vertical cross-sectional view of a sprinkler head according to a second embodiment of the present invention.

FIG. 12 is an exploded perspective view showing the sprinkler head shown in FIG. 11.

FIG. 13 shows a plan view, a front view, and a cross-sectional view taken along the line C-C of a thermosensitive plate cover shown in FIG. 11.

FIG. 14 shows a perspective view (a state viewed from below) and a front view of a slider shown in FIG. 11.

FIG. 15 shows a plan view, a front view, a side view, a perspective view, and a cross-sectional view taken along the line E-E of a disk spring shown in FIG. 11.

FIG. 16 illustrates cross-sectional views showing a state of operation of the sprinkler head shown in FIG. 11.

FIG. 17 is a partial enlarged view showing a modification of a thermosensitive portion.

FIG. 18 is a partial enlarged view showing another modification of the thermosensitive portion.

FIG. 19 is a partial enlarged view showing a plunger provided with a heat insulating member.

### DESCRIPTION OF EMBODIMENTS

### First Embodiment

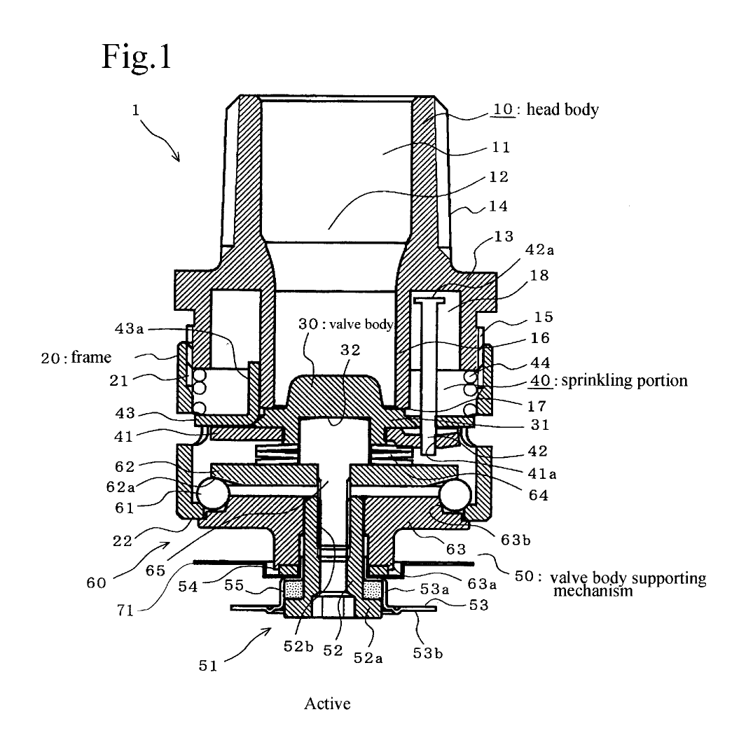

### FIG. 1 to FIG. 10

FIG. 1 is a vertical cross-sectional view of a sprinkler head according to a first embodiment of the present invention.

A sprinkler head 1 includes a head body 10, a frame 20, a valve body 30, a sprinkling portion 40, and a valve body supporting mechanism 50 (ball holding mechanism 60).

The head body 10 is opened at a center portion thereof. An opening portion 11 forms a water discharging port 12 together with a water discharging cylinder 16, described later. Formed on an outer peripheral portion of the head body 10 is a flange 13, formed on the outer peripheral portion of the head body 10 on an upper side of the flange 13 is a screw portion 14 to be connected to a water supply pipe, and formed on an outer peripheral portion of a lower side of the flange 13 is a screw portion 15 for allowing attachment of the frame 20, described later.

Formed inside the head body 10 is the cylindrical water discharging cylinder 16 projecting downward. Also, for example, a valve seat 17 formed into a flat shape is formed at a lower end portion of the water discharging cylinder 16, and is closed by the valve body 30. A shoulder which allows an outer periphery of the valve body 30 to fit thereon may be provided at the lower end portion of the water discharging cylinder 16. The head body 10 is formed with a substantially hole-shaped or a substantially ring-shaped space 18 between an inner peripheral portion of the lower side of the flange 13 and the water discharging cylinder 16 and a guide rod 42, described later, is stored in the space 18.

The frame 20 is formed into a cylindrical shape. A screw portion 21 is formed on an inner peripheral portion of an upper portion of the frame 20, and is engaged with the screw portion 15 formed on the side of a lower portion of the head body 10. Provided on a lower portion of the frame 20 is a locking shoulder portion 22 projecting inward, and balls 61, described later, will be locked with the locking shoulder portion 22.

The valve body 30 is formed into a protruding shape, includes a flange portion 31 at a lower portion thereof, and the valve seat 17 of the head body 10 is closed by the flange portion 31. The valve seat 17 may be provided with a Teflon (registered trademark) sheet or coated by Teflon (registered trademark). For reference sake, the valve body 30 is formed with a depression 32 at the center of the lower portion, and allows a head portion of a set screw 65, described later, to be inserted herein. The valve body 30 is supported by the valve body supporting mechanism 50, described later.

The sprinkling portion 40 is provided with a deflector 41, the guide rods 42, and a stopper ring 43 (and the valve body 30). The sprinkling portion 40 is provided in the frame 20. For reference sake, the deflector 41 may be provided on the lower portion of the frame 20, and hence at least part of the sprinkling portion 40 is provided in the interior of the frame 20.

The deflector 41 is formed of a disk having an opening portion at the center thereof, and is attached (fixed) to a lower surface of the flange portion 31 of the valve body 30 in a state in which the lower portion of the valve body 30 is inserted into the opening portion. Also, the deflector 41 is formed with (three, for example) insertion holes 41a which allow insertion of (three, for example) the guide rods 42, and lower ends of the guide rods 42 are secured to the deflector 41 in a state of being projected from the insertion holes 41a. Therefore, the valve body 30, the deflector 41, and the guide rods 42 are formed integrally.

Here, the state of mounting the deflector 41 to the valve body 30 will be described in detail. The valve body 30 includes the flange portion 31 which comes into contact with the valve seat 17 for maintaining water stop, and a cylindrical leg portion projecting downward from the flange portion 31. An upper portion of the leg portion is formed into a groove portion having a diameter slightly smaller than a center opening portion (hole) of the deflector 41, and a lower side of the groove portion is formed into a cylindrical shape having a diameter slightly larger than the hole diameter of the center opening portion of the deflector 41. Therefore, the deflector 41 is in a state of rotatable at a position connected to the valve body 30 (the groove portion).

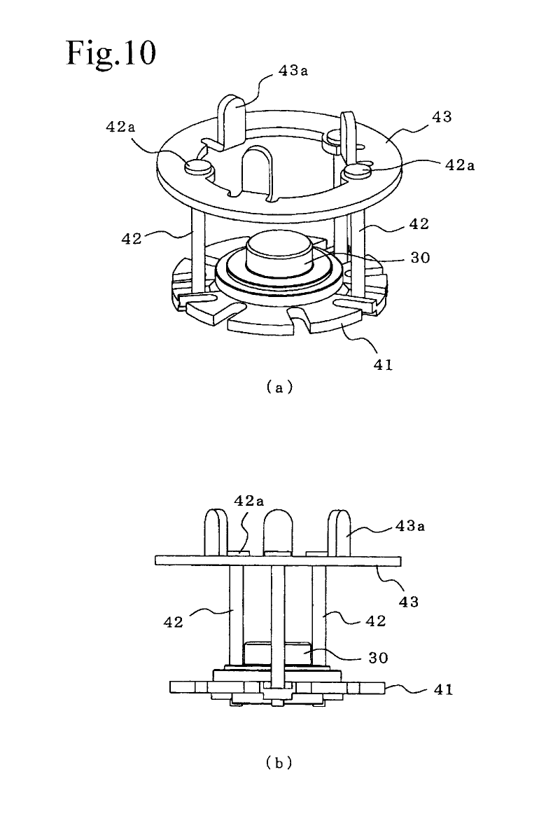

The guide rods 42 are each formed with a shoulder 42a widened in diameter for a stopper at an upper end thereof, and the stopper ring 43 formed into a doughnut shape is attached to the guide rods 42 so as to be movable in the vertical direction (see FIG. 10).

The stopper ring 43 is provided with (three, for example) insertion holes for allowing the guide rods 42 to be inserted thereto and, the stopper ring 43 is attached to the guide rods 42 so as to be movable to the locking shoulder portion 22 using this insertion holes by sliding along the guide rods 42 at the time of water discharge operation. When viewed from the other side of the coin the guide rods 42 are mounted to the stopper ring 43 so as to be movable downward along the insertion holes of the stopper ring 43 at the time of water discharge operation. For reference sake, this insertion hole is formed to be smaller than the shoulder 42a. The stopper ring 43 is installed on the deflector 41 in the normal state, and is provided at a substantially midsection of the frame 20 in the height direction at a position opposing a slit provided on the frame 20. For reference sake, the slit does not necessarily have to be provided at the position opposing the stopper ring 43.

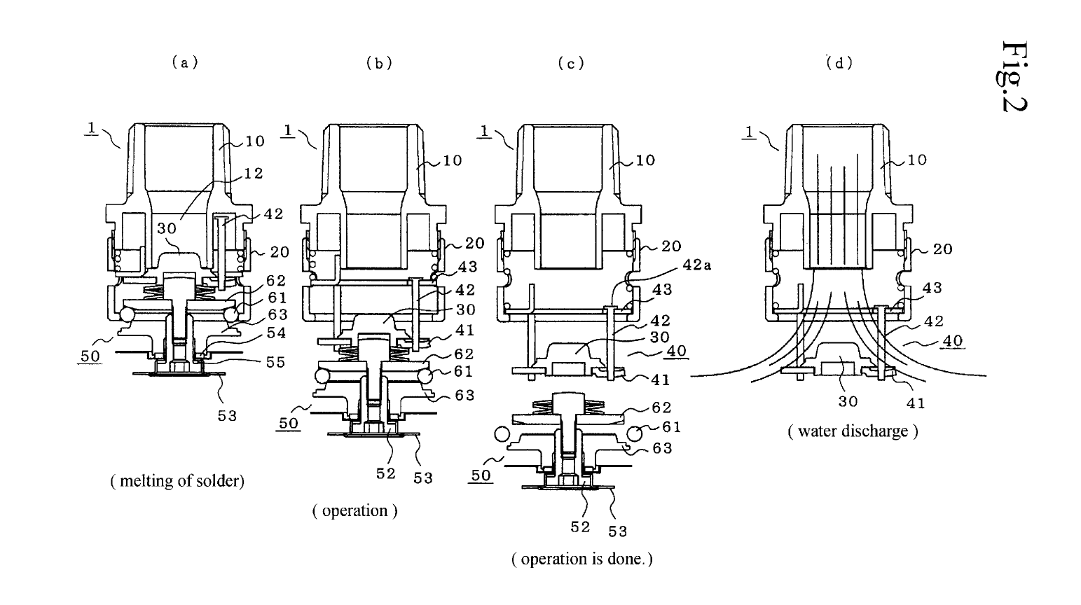

In the normal state, a lower surface of the stopper ring 43 is pressed by a coil spring 44 and is located at a position substantially overlapped with an upper surface of the deflector 41. However, at the time of water discharge operation, the deflector 41 and the guide rods 42 move downward, and the shoulder 42a at an upper end of the guide rods 42 moves downward until it comes into abutment with the stopper ring 43 (see FIG. 2(c)). The outer diameter of the stopper ring 43 is formed to be larger than the inner diameter of the locking shoulder portion 22 of the frame 20, and when the valve body supporting mechanism 50 drops at the time of water discharge operation, the stopper ring 43 is pressed by the coil spring 44, and moves downward to the locking shoulder portion 22 of the frame 20.

For reference sake, the coil spring 44 has a size (outer diameter) which comes into abutment with an inner peripheral surface of the frame 20, and is provided between a lower side of the outer peripheral portion of the head body 10 and an outer peripheral portion of the stopper ring 43, so that a large space is not necessary to install the coil spring 44.

The inner diameter of the hole provided at the center of the stopper ring 43 is formed to be slightly larger than the outer diameter of the water discharging cylinder 16. Then, the stopper ring 43 is formed with guide members 43a having a cross-section in a L-shape by bending parts of an inner periphery thereof upward via notched grooves, for example, at three points of the inner periphery. When the stopper ring 43 moves downward, the stopper ring 43 is guided by the guide members 43a to an outer periphery of the water discharging cylinder 16 formed on the lower portion of the head body 10. The number and the pitch of the guide members 43 are set as needed so as to allow the stopper ring 43 to move downward in a balanced manner.

The valve body supporting mechanism 50 includes a thermosensitive portion 51, the ball holding mechanism 60, a disk spring 64, and the set screw 65.

The thermosensitive portion 51 includes a plunger 52, a thermosensitive plate 53, and a heat insulating member 54.

The plunger 52 is formed into a cylindrical shape and is formed with a flange portion 52a on a lower portion thereof. Also, the flange portion 52a is formed with a lower surface thereof projecting from a lower surface of the thermosensitive plate 53. The plunger 52 is formed with a female screw 52b in the interior thereof, and a male screw on a leg portion of the set screw 65 is screwed therein, so that the both are coupled to each other. A doughnut-shaped thermosensitive member (for example, solder or the like) 55 is inserted from above the plunger 52, and is placed on the flange portion 52a of the plunger 52. Provided on the thermosensitive member 55 is the thermosensitive plate 53 having a disk shape and a crank-shaped cross section. In other words, the thermosensitive plate 53 includes a protruded portion 53a configured to cover the thermosensitive member 55 provided on the flange portion 52a of the plunger 52, and a disk portion 53b continuing from the protruded portion 53a and extending in the direction orthogonal to an axial core of the head body 10. Then, a force to compress the thermosensitive member 55 is applied to the thermosensitive plate 53 by the ball holding mechanism 60, described later.

The heat insulating member 54 formed into a doughnut shape is provided on an upper portion of the thermosensitive plate 53 and configured to prevent heat received by the thermosensitive plate 53 from escaping toward a balancer 63, described later. As shown in FIG. 1, a separate thermosensitive plate 71 having a larger diameter may be provided between the heat insulating member 54 and the thermosensitive plate 53 as needed.

The ball holding mechanism 60 includes the balls 61, a slider 62, the balancer 63, and the disk spring 64. For reference sake, the balancer 63 has a function to compress the thermosensitive member 55, and hence has a function corresponding to a piston.

A lower portion of an outer periphery of the ball 61 is locked into the locking shoulder portion 22 of the frame 20. It is the slider 62 which holds the balls 61 from above in this state, and a force is applied from the slider 62 to the balls 61, and hence the force acts on the balls 61 in the direction of moving inward.

The balancer 63 is provided inside the balls 61, and restricts the movements of the balls 61 moving inward. Both of the slider 62 and the balancer 63 are formed into a disk shape, have a through hole at the centers thereof, and the plunger 52 penetrates through the through hole of the balancer 63. The outer diameter of the plunger 52 is slightly smaller than the inner diameter of the through hole of the balancer 63, and both of these members are not coupled. Also, the inner diameter of the through hole of the slider 62 is formed to be slightly larger than the outer diameter of the leg portion of the set screw 65, and both of these members are not coupled.

The balancer 63 includes a cylindrical portion having a through hole and a disk portion provided on an upper portion of the cylindrical portion combined to each other. The balancer 63 is formed with a shoulder on an outer periphery of a lower portion thereof. The shoulder on the outer periphery of the lower portion is configured to come into abutment with a shoulder provided on an inner periphery of a lower portion of the locking shoulder portion 22 of the frame 20 and, when an external force is applied from a lower side of the balancer 63, the impact is absorbed by this portion. Also, projecting from around the through hole on the lower portion of the cylindrical portion of the balancer 63 and around the through hole at the center is a shoulder 63a which allows fitting of the heat insulating member 54, and projecting on an upper portion of the disk portion of the balancer 63 is a ball-receiving shoulder 63b which allows an abutment with the balls 61.

A depression 62a is formed on a lower portion of an outer peripheral side of the slider 62, and the surface of the depression 62a where the balls 61 come into contact with is formed into a tapered shape (inclined portion) so as to incline inward as it goes downward.

Since a force to cause the balls 61 to move inward is always applied to the balls 61 as described above, a force to move the balancer 63 downward and the slider 62 upward acts. Therefore, when the solder as the thermosensitive member 55 is melted and flowed out, the balancer 63 moves downward and, accordingly, the balls 61 enter inwards and hence the locked state with respect to the locking shoulder portion 22 of the frame 20 is released. Therefore, the ball holding mechanism 60 drops down together with the thermosensitive portion 51. When the ball holding mechanism 60 drops downward, the valve body 30 and the stopper ring 43 or the like which constitute the sprinkling portion 40 drop down accordingly, so that water discharge is performed.

The set screw 65 is a bolt including a large-diameter head portion and a small-diameter leg portion, and when a lower portion of the leg portion is coupled with an upper portion of the plunger 52, the balancer 63 as the ball holding mechanism 60, the slider 62, and the thermosensitive portion 51 are integrated to each other.

The disk spring 64 having a through hole 64a at the center thereof as shown in FIG. 9 is used. Then, slits 64b are provided from the through hole 64a at the center radially at regular intervals of 60°. Also, through holes 64c are provided between the slits 64b. The disk spring 64 is composed of one or a combination of a plurality of pieces and, for example, three pieces are combined in the vertical direction and are arranged between the valve body 30 and the slider 62. For reference sake, detailed description of the disk spring 64 will be given later.

The disk spring 64 allows insertion of the set screw 65 in the interior of the through hole 64a, and is provided between the valve body 30 and the slider 62. In other words, the through hole 64a of the disk spring 64 is formed to be substantially the same as or slightly larger than the outer diameter of the head portion of the set screw 65. Also, the height of the head portion of the set screw 65 is formed to be larger than the free height of the stacked plurality of pieces of the disk spring 64, and serves as a role of a guide when the disk springs 64 are stacked. When the height of the head portion of the set screw 65 is low, the disk springs 64 may not function if the disk springs 64 are collapsed more than necessary at the time of assembly. Therefore, by setting the height of the head portion of the set screw 65 to an extant which can avoid such an event, the disk springs 64 can be held in a stable state.

In a state shown in FIG. 1, in the sprinkler head 1 as described above, a water pressure of fire service water at the water discharging port 12 or an assembling load acts on the balls 61 and hence the balls 61 make an attempt to move inward (toward the center), the balls 61 are prevented from moving by the balancer 63, and the ball holding mechanism 60 holds the balls. Then, in this state, the disk springs 64 press the valve body 30 upward, and the valve body 30 seals the water discharging port 12 of the head body 10. Therefore, the sprinkler head 1 receives a supply of pressurized fire service water, but the fire service water does not leak out. Also, in the sprinkling portion 40, the deflector 41 is fixed to the valve body 30, and the guide rods 42 are fixed to the deflector 41 and, in the state in which the valve body 30 seals the water discharging port 12, the guide rods 42 are in a state of being stored in the space 18 of the head body 10.

The operation of the sprinkler head 1 shown in FIG. 1 will be described.

FIGS. 2(a) to (d) are drawings showing a process of operation of the sprinkler head 1.

(a) In a monitoring state of the sprinkler head 1, pressurized fire service water is supplied to the water discharging port 12 of the head body 10, and the pressure of the fire service water is applied to the valve body 30 (see FIG. 1). When the fire breaks out and hot air hits on the thermosensitive plate 53, the thermosensitive plate 53 is heated and the heat of the thermosensitive plate 53 is propagated to the thermosensitive member 55. Then, when the thermosensitive member 55 is heated from the periphery thereof and is started to melt, the melted thermosensitive member 55 flows out from a gap formed between the plunger 52 and the thermosensitive plate 53 (the protruded portion 53a) and the volume thereof is reduced (FIG. 2(a)).

At this time, the balls 61 pressed from above by the slider 62 receive a force to cause the same to move inward and, as descried later, even when the balancer 63 is moved downward toward the thermosensitive plate 53 and the balls 61 are moved, the valve body 30 is brought into a press-contact with the valve seat 17, and a state of closing the water discharging port 12 is maintained. This occurs because of the action of the disk springs 64 and, by stacking a plurality of the disk springs 64, the disk springs 64 have a predetermined amount of stroke enough to maintain the sealed state by the valve body 30. In this manner, the valve body 30 is prevented from coming apart from the valve seat 17 until the ball holding mechanism 60 is completely dropped, so that the reliable operation is ensured.

(b) When the thermosensitive member 55 is melted and flowed out to the outside, the thermosensitive plate 53 moves downward corresponding to the amount of outflow of the thermosensitive member 55. When the thermosensitive plate 53 is moved downward, the heat insulating member 54 and the balancer 63 mounted on the thermosensitive plate 53 are moved downward. When the balancer 63 is moved downward, a gap between the balancer 63 and the slider 62 is increased, and the balls 61 urged inward move inward beyond the shoulder 63b of the balancer 63, so that the engagement between the locking shoulder portion 22 of the frame 20 and the balls 61 is released. Accordingly, the valve body 30 and the valve body supporting mechanism 50 move downward (FIG. 2(b)).

(c) When the valve body supporting mechanism 50 including the disk springs 64 arranged below the valve body 30 drops, the valve body 30 moves downward. Also, in association with the downward movement of the valve body 30, the deflector 41 attached to the valve body 30, the guide rods 42 attached to the deflector 41, and the stopper ring 43 move downward. When the guide rods 42 move downward, the shoulder 42a provided on an upper portion thereof is locked with the stopper ring 43, and the stopper ring 43 is locked with the locking shoulder portion 22 of the frame 20, and the valve body 30 and the deflector 41 are brought into a state of being suspended from the frame 20 by the guide rods 42 (FIG. 2(c)). For reference sake, at the time of this operation, there may be a case where the stopper ring 43 is moved downward together with the guide rods 42 until being locked with the locking shoulder portion 22, and after the stopper ring 43 has locked, only the stopper ring 43 is moved further downward.

In this embodiment, in the water discharge operation, the deflector 41 is moved downward together with the guide rods 42 while being guided by the guide member 43a, so that the operation of the deflector 41 moving downward is performed smoothly. Also, by providing the stopper ring 43 at a substantially midpoint of the frame 20 in the height direction, the amount of downward movement of the stopper ring 43 itself can be reduced, so that the operation at the time of water discharge is smoothened.

Incidentally, the guide member 43a of the stopper ring 43 is folded upward, and hence an obstacle of sprinkling of water at the time of water discharge can hardly occur. This point will be described. Some of the guide members of the related art are bent downward. However, in this case, if the guide member is long or thick and water hit on the valve body splashes at the time of water discharge, water hits on the guide member and hence the guide member becomes the obstacle of sprinkling of water. In other words, the guide member 43a is bent upward to increase the distance from the valve body 30 at the time of water discharge, whereby the guide member 43a is prevented from becoming the obstacle of sprinkling of water.

(d) In this manner, when the valve body 30 is moved downward, the water discharging port 12 is opened, and the pressurized fire service water is sprinkled via the deflector 41 and extinguishes the fire (FIG. 2(d)).

Subsequently, characteristic parts of the plunger 52, the slider 62, and the disk springs 64, which are the respective components which constitute the sprinkler head of the present invention will be described respectively in detail.

(Plunger 52)

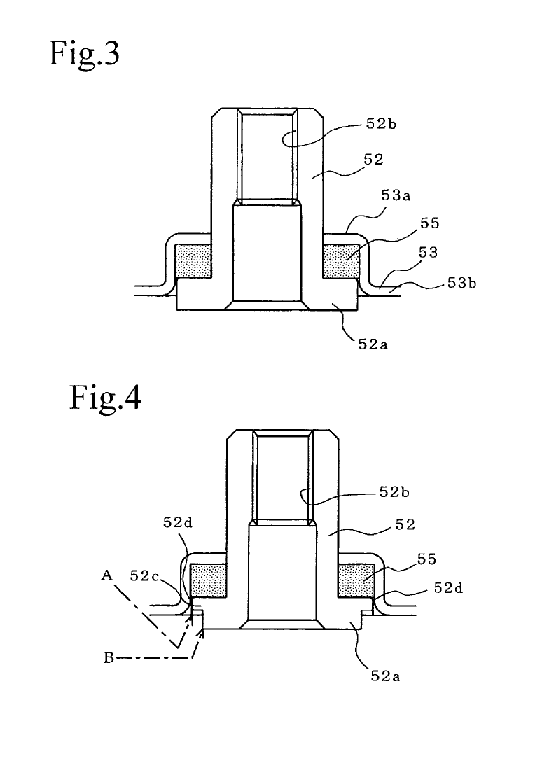

FIG. 3 is a cross-sectional view showing the plunger 52 in detail.

The plunger 52 in FIG. 1 is provided so that a distal end portion thereof projects downward from the thermosensitive plate 53 as described above. FIG. 3 shows the corresponding portion extracted from FIG. 1. When something hits on the sprinkler head 1 (especially from below), since the plunger 52 projects in this manner, the something is prevented from hitting on the plunger 52 and the something is prevented from hitting on the thermosensitive plate 53. Since the plunger 52 is formed of a member which increases the rigidity thereof in comparison with the thermosensitive plate 53, there is no probability of deformation. Therefore, there is no probability that the plunger 52 digs into the thermosensitive plate 53, and hence the malfunction does not occur.

Also, an upper end portion of the plunger 52 has a length reaching an upper end of the balancer 63 (see FIG. 1), and the set screw 65 and the plunger 52 are coupled, so that the rigidity is high. Therefore, even when an external force is applied to the sprinkler head 1 from the side, there is no probability of deformation of the plunger 52 or the set screw 65, and hence the malfunction does not occur. In particular, the shoulder provided on the outer periphery of the lower portion of the balancer 63 is locked with the shoulder on the inner periphery of the lower portion of the locking shoulder portion 22, and hence is robust over the external force from the side or from below, and the received external force is transferred to the frame 2.

Subsequently, an example of the plunger 52 configured to cope with the external force applied to the sprinkler head 1 from obliquely below will be described with reference to FIG. 4 to FIG. 6.

FIG. 4 shows an example in which a shoulder 52c enlarged in diameter is provided on an upper portion of the flange portion 52a at a lower end of the plunger 52. In other words, it is an example in which a shoulder with a reduced diameter is provided on the lower portion of the flange portion 52a.

With the provision of the shoulder 52c as described above on the flange portion 52a of the plunger 52, the external force is applied firstly to a corner portion (point B), and hence a corner portion (point A) is prevented from being deformed due to the external forces from below and obliquely from below. Also, even when the corner portion (point B) is deformed, since the shoulder 52c enlarged in diameter is formed on an upper side of the deformed portion, the deformed portion is prevented from closing a gap 52d formed between the plunger 52 and the thermosensitive plate 53 and from causing the plunger 52 and the thermosensitive plate 53 to engage and couple to each other by deformation, so that the operability is not affected.

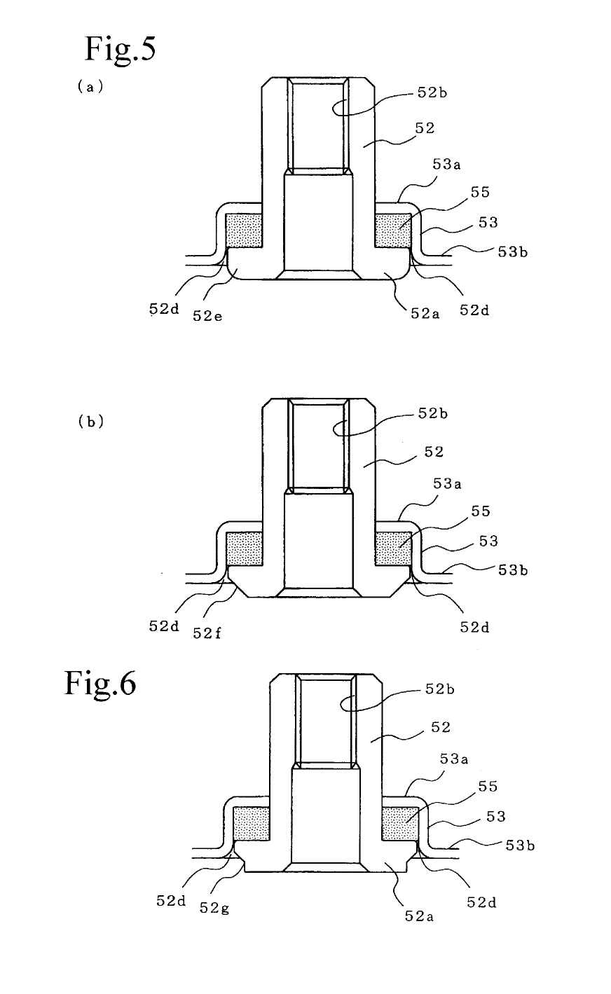

FIGS. 5(A) and (B) are examples in which a rounded R surface 52e or a taper (chamfered C surface) 52f is provided at a lower end of the flange portion 52a of the plunger 52.

Since the lower end of such a flange portion 52a of the plunger 52 is formed to have a smaller diameter than an upper portion of the flange portion 52a, even when the lower end portion is deformed by the external forces from below and the obliquely below, there is no probability that the deformed portion closes the gap 52d or causes the plunger 52 and the thermosensitive plate 53 to engage or couple to each other due to the deformation thereof, and the operability is not affected.

FIG. 6 shows an example in which a shoulder is provided on an upper portion of the flange portion 52a of the plunger 52, and a taper 52g is provided on a lower portion thereof, which is a shape assembling the shapes shown in FIG. 4 and FIG. 5(B). Since the portion of the flange portion 52a of the plunger 52 is formed in such a manner, even when the lower end portion of the flange portion 52a is deformed by the external forces from below and the obliquely below, there is no probability that the deformed portion closes the gap 52d or causes the plunger 52 and the thermosensitive plate 53 to engage or couple to each other due to the deformation thereof, and the operability is not affected.

In this manner, the plunger 52 according to the present invention is provided with the shoulder, the tapered surface or the R-surface on the lower end of the flange portion 52a, even when the lower end portion is deformed by the external force from below or from obliquely below, the lower side of the flange portion 52a and the protruded portion 53a of the thermosensitive plate 53 are arranged at a predetermined gap. Therefore, in other words, a positional relationship such that the lower side portion of the flange portion 52a is arranged so as to inscribe in the protruded portion 53a of the thermosensitive plate 53 via the predetermined gap is maintained, the operability is not affected even when the thermosensitive plate 53 is deformed by being applied with the external force. For reference sake, the gap may be filled with solder.

(Slider 62)

First of all, a configuration which is required for the sprinkler head 1 having the ball holding mechanism 60 including the slider 62, the balls 61, and the like. When the valve body 30 comes apart from the valve seat 17 before the balls 61 completely comes off from the locking shoulder portion 22 of the frame 20, there arises a risk of becoming inoperative due to the leakage during the operation. Therefore, a remaining load which supports the valve body is necessary in the sprinkler head 1. In order to secure the remaining load, it is necessary to suppress the amount of downward movement of the slider 62 (referred to as the operation stroke). Therefore, in the related art, by using the spring having the high amount of displacement such as the coil spring, the amount of displacement of the coil spring is set to be larger than the operation stroke of the slider 62, whereby leakage of water during the operation is prevented.

In the present invention, the operation stroke of the slider 62 is reduced by changing the shape of the slider 62, and the amount of displacement of the disk spring itself is increased by devising the shape of the disk springs 64, whereby the massive coil spring is no longer necessary to use.

Returning back to FIG. 1 now, when focusing on the shape of the slider 62, the surface of the depression 62a on the side of the outer peripheral portion of the slider 62, which comes into contact with the balls 61, is tapered, and the tapered surface is in contact with the balls 61.

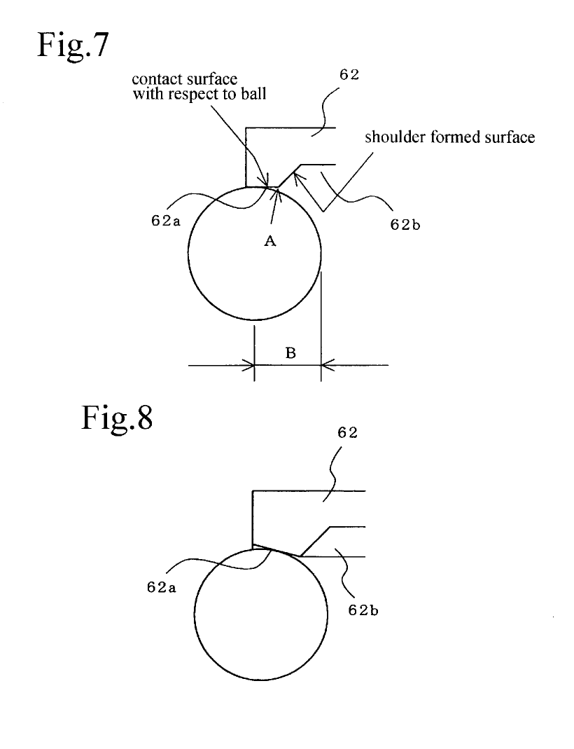

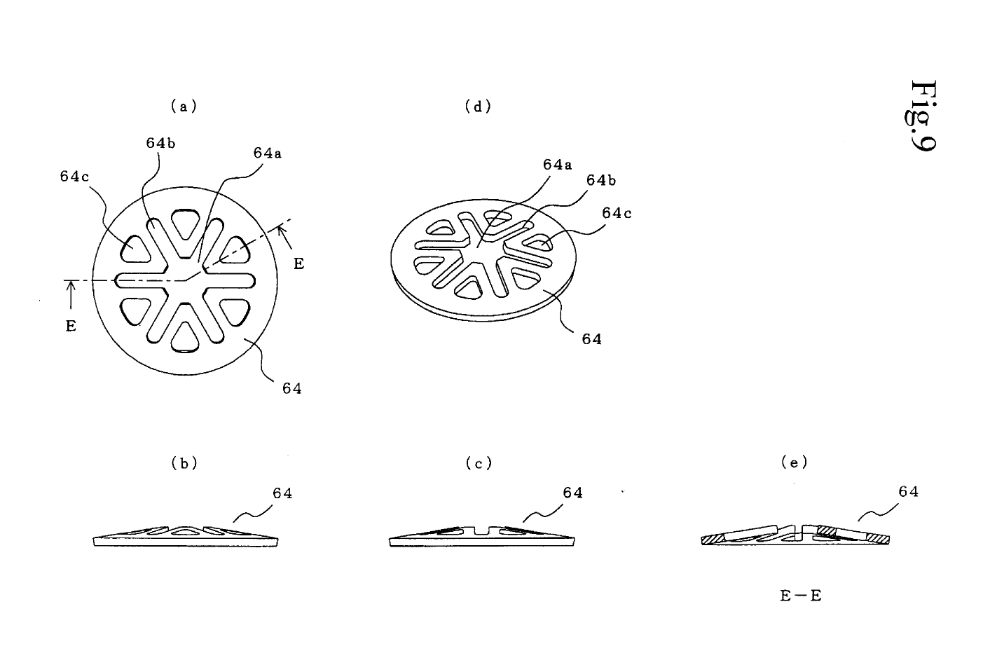

With the employment of the slider 62 having such a shape, the amount of movement (operation stroke) in the axial direction of the slider 62 when the balls 61 enter inside the slider 62 and climb over the balancer 63 may be small in comparison with the case where the slider 62 is not provided with the depression on the inner side thereof and hence is flat (related art), and hence the amount of displacement required for the disk springs 64, that is, the stroke required for bringing the valve body 30 into press contact with the valve seat 17 until the balls 61 completely come off from the locking shoulder portion 22 can be reduced. A modification of the slider 62 will be described with reference to FIG. 7 and FIG. 8.

FIG. 7 is an example in which a recessed portion 62b for a ball is provided on the slider 62. The recessed portion 62b includes a depression formed on a lower surface of the slider 62. In this drawing, a point of the contact surface with respect to the ball 61 where the shoulder formed surface starts (point A) is located on the side of the axial center of the head within a range from the position of the center of the ball at a distance equal to or smaller than the radius of the ball (within a range indicated by B). In FIG. 7, at the time of operation of the sprinkler head, when the ball 61 enters inside the slider 62, the ball 61 moves so as to enter the recessed portion 62b, and hence the ball 61 accelerates the operation of the balls 61 to move away from the locking shoulder portion 22, whereby the amount of movement of the ball 61 in the axial direction is reduced, thereby reducing the operation stroke.

FIG. 8 is an example in which the taper is formed on a contact surface with respect to the ball of the slider 62 in FIG. 7. The slider 62 is an example in which the taper surface in FIG. 1 and the recessed portion 62b in FIG. 7 are combined.

(Disk Spring 64)

Subsequently, the disk springs 64 in FIG. 1 will be described.

FIGS. 9(a), (b), (c), (d), and (e) show a plan view, a front view, a side view, a perspective view, and a cross-sectional view taken along the line E-E of the disk spring.

The disk springs 64 is formed with a through hole 64a at the center thereof, and six slits 64b are provided radially so as to continue to the through hole. Provided between the slits are fan-shaped (triangular shape with arcuate-shaped corners) through holes 64c.

The disk springs 64 is provided with the six slits 64b as described above, and if the number of the slits 64b is as small as, for example, four (the related art), there arise problems such that the stress is increased and hence the disk spring may be broken, may be result in buckling, or may be subject to a secular change. Also, there are as many as 10 or more slits 64b (the related art), there may arise problems such that the load may become insufficient, the amount of deflection may become insufficient, or the disk spring cannot be restored to its original shape. In these reasons, in this embodiment, the number of slits 64b is set to, for example, six.

Although the through holes 64c are provided between the slits 64b, it is for reducing the stress which is applied to the disk springs 64. When there is no through holes 64c between the slits 64b, there may arise problems such that a large stress is generated and hence the disk spring is broken or the cracks may be generated.

Also the shape of the through holes 64c between the slits has a triangular shape having arcuate-shaped (fan-shaped) corners. This is to disperse the stress applied to the respective parts. If the shape of the through holes is an elongated shape or a square as in the related art, the stress cannot be dispersed and hence the disk spring may be broken when a large load is applied thereto.

Also, advantages of the disk spring 64 described above will be described from another point of view.

The disk spring 64 is divided into a portion which receives the load and a deflecting portion formed on the inner peripheral portion (center side). The circumferential portion (the outer peripheral portion) of the disk spring corresponds to the portion which receives the load, and the shape of the slit portions corresponds to the deflecting portion. By changing these two portions with a balanced manner, a load to be applied to the disk spring and the amount of deflection thereof may be controlled arbitrarily. In addition, in order to disperse the stress, the breakage or the buckling does not occur. Therefore, both of the high load and a high amount of displacement, which cannot be achieved in the disk spring of the related art are achieved.

In this embodiment, the disk spring having a shape of a lotus root in cross section and including radial slits and through holes provided between the slits is used to secure the assembly load and the stroke required for the stroke. However, the shape of the dish spring used in the spring head is not limited to this shape. For example, it is also possible to use a single or a plurality of dish springs of a similar shape may be combined as needed.

### Second Embodiment

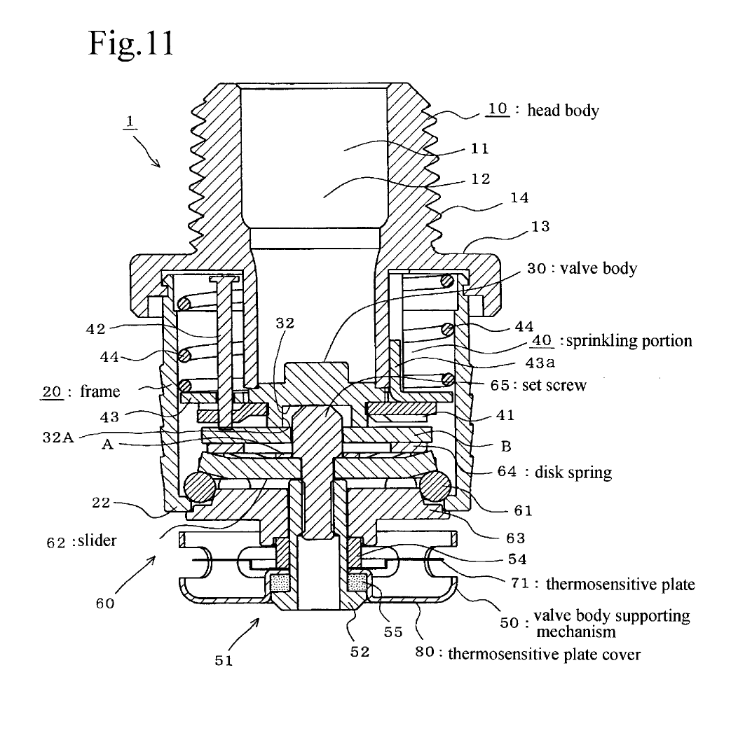

### FIG. 11 to FIG. 16

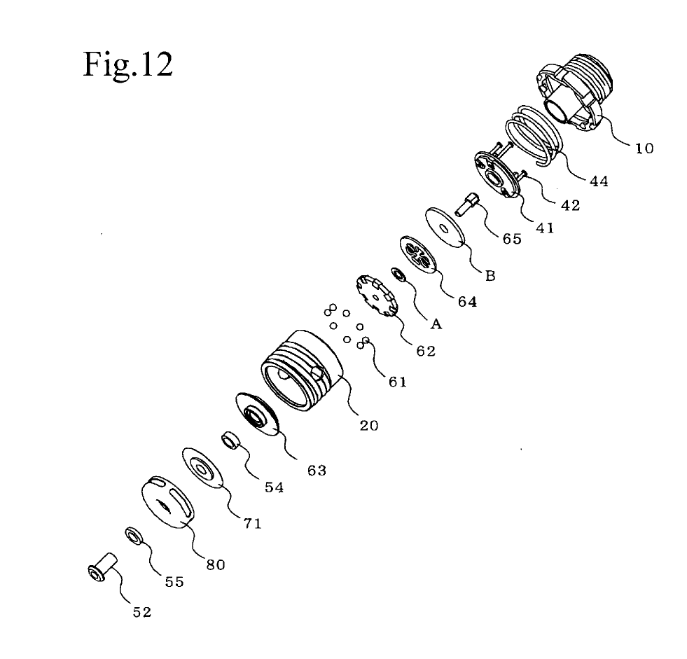

FIG. 11 is a vertical cross-sectional view of a sprinkler head according to a second embodiment of the present invention, and FIG. 12 is an exploded perspective view showing the sprinkler head shown in FIG. 11. In these drawings, the same reference numerals as those in FIG. 1 have the same name and the same function, and different points from the embodiments described above will mainly be described. In FIG. 12, illustration of the coil spring 44 is omitted.

(Head Body 10)

The coupling relationship between the head body 10 and the frame 20 is such that the head body 10 is formed with a female screw, and the frame 20 is provided with a male screw, and the male screw of the frame 20 engages the female screw of the head body 10 so that the both are coupled. Therefore, in the coupling relationship between the head body 10 and the frame 20, the relationship between the male screw and the female screw is vice versa in comparison with the embodiment shown in FIG. 1.

(Valve Body 30)

The valve body 30 of the sprinkler head is the same in having a depression on the lower portion of the valve body 30 for allowing the upper portion of the set screw 65, but a washer B is provided between the disk spring 64 having the set screw 65 inserted therethrough and the valve body 30. The washer B has a doughnut shaped disk having a predetermined thickness. There are formed a lower end of the guide rod 42, and a wind (claw) of the deflector 41 formed on a portion opposing the guide rod 42 by being bent downward on lower surface of the deflector 41 of the sprinkling portion 40 as protruding portions as shown in FIG. 11. Therefore, with the provision of the washer B, the protruding portions on the lower surface of the deflector 41 are received by an upper surface of the washer B, so that a uniform force is applied to the disk spring 64.

(Sprinkling Portion 40)

The sprinkling portion 40 of the sprinkler head has the same basic configuration as that in the first embodiment shown in FIG. 1. However, the coil spring 44 is mounted between the upper portion of the space 18 of the head body 10 and the stopper ring 43, which is a different point from the example in FIG. 1.

(Plunger 52)

The plunger 52 has a basic configuration which is the same as that in FIG. 5(b), and the operation and effects are the same as those in description of the first embodiment (see paragraphs 0049 and 0050). The taper (chamfered C surface) 52f is provided on the plunger 52 at the lower end of the flange portion 52a thereof. Since the lower end of the flange portion 52a of the plunger 52 is formed to have a smaller diameter than the upper portion of such a flange portion 52a, even when the lower end portion is deformed by the external forces from below and the obliquely below, there is no probability that the deformed portion closes the gap 52d or causes the plunger 52 and the thermosensitive plate cover 80 to engage or couple to each other due to the deformation thereof, and the operability is not affected.

(Thermosensitive Plate Cover 80)

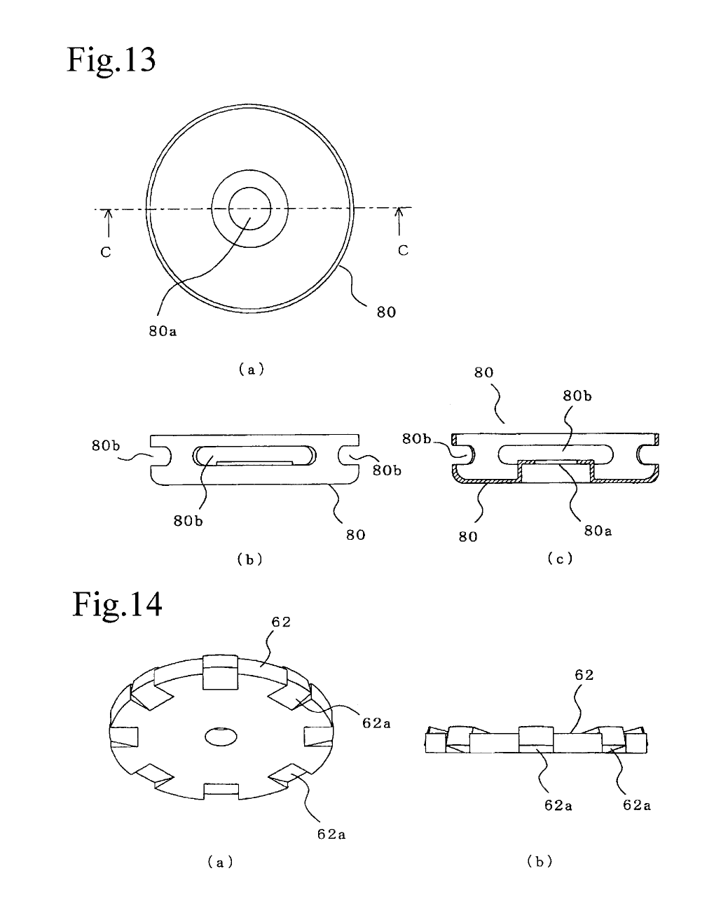

FIGS. 13 (a), (b), and (c) show a plan view, a front view, and a cross-sectional view taken along the line C-C of the thermosensitive plate cover 80.

The thermosensitive plate cover 80 is different from the first embodiment in that the thermosensitive plate 53 in the first embodiment is formed into a bowl shape so as to be capable of covering the thermosensitive plate 71 provided on an upper side. In other words, the thermosensitive plate cover 80 is formed into a bowl shape, and an upper portion of an annular side wall portion is opened, and an opening portion 80a which allows insertion of the plunger is formed at the center portion thereof. The side wall portion is formed with a slit-shaped opening portion 80b for taking outside air toward the thermosensitive plate 71. The thermosensitive plate cover 80 stores the thermosensitive plate 71, the opening portion 80b allows the peripheral edge portion of the thermosensitive plate 71 to be exposed so that the peripheral edge portion of the thermosensitive plate 71 is positioned at the center portion in the height direction (see FIG. 11), and hot air comes into direct contact with the peripheral edge portion of the thermosensitive plate 71. In this manner, the outer diameter of the thermosensitive plate 71 is used here as large as being substantially the same as the diameter of the locking shoulder portion 22 of the frame 20 on the inner peripheral side so that the hot air passing through the opening portion 80b hits directly thereon.

The thermosensitive plate 71 is formed into a flat panel shape as shown in FIG. 11 and FIG. 12, and is thermally connected to the thermosensitive member 55 via an outside portion of the opening 80a of the metallic thermosensitive cover 80. Then, the thermosensitive plate 71 is stored in the thermosensitive plate cover 80 as described above. For the reference sake, the thermosensitive plate 71 only has to be capable of transferring heat to the thermosensitive member 55. Therefore, as long as it is achieved, contact of the thermosensitive plate 71 to the thermosensitive member 55 may either be direct or indirect.

The thermosensitive plate cover 80 is formed of the metallic member, the lower portion thereof is formed so as to wrap the thermosensitive member 55 and to be in contact with the thermosensitive member 55 in the same manner as the thermosensitive plate 71 in FIG. 1 (see FIG. 11), and functions as the thermosensitive plate. The thermosensitive plate cover 80 serves to protect the thermosensitive plate 71 from the external force and when the same material as the thermosensitive plate 71 is used, the thickness is increased. For example, when the thickness of the thermosensitive plate 71 is from 0.05 mm to 0.1 mm, the thickness of the thermosensitive plate cover 80 is set from 0.2 mm to 0.3 mm.

For the reference sake, the height of the opening portion 80b of the thermosensitive plate cover 80 is designed so that a lower side of the opening portion 80b is almost the same as or lower than an upper surface of the thermosensitive member 55 and, the width of the opening portion 80b is formed to be larger than the outer diameter of the doughnut shaped thermosensitive member 55 (that is, the outer diameter of the plunger 52). Accordingly, the hot air passed through the opening portion 80b accelerates heating of the thermosensitive member 55.

The larger the surface area of the opening portion 80b of thermosensitive plate cover 80, or the larger the number of the opening portions 80b, the more the hot air is fed to the thermosensitive plate 71. However, from the facts that the hot air is flowed easier with the opening portions formed so as to oppose to each other, and that the larger the beam (columns) formed between the opening portion and the opening portion, the larger the resistance against the external force becomes (the stronger the strength becomes), the four opening portions 80b are provided at regular intervals in this embodiment.

(Slider 62)

FIGS. 14(a), (b) are a perspective view and a front view of the slider 62 of the ball holding mechanism 60.

The slider 62 in the first embodiment is formed by cutting a lower surface of a flat plate over an entire circumference to form the depressions 62a as contact surfaces of the balls 61. In contrast, the slider 62 in this embodiment is formed by applying a pressing process on a flat plate. In other words, the depressions 62a are formed by bending portions of the contact surfaces with the balls 61 obliquely upward.

Provided between the slider 62 and the disk spring 64 is a washer A. The washer A is configured from a doughnut-shaped thin disk. The reason why the washer A is provided is to cause the washer A to function as a spacer for keeping the distance between the disk spring 64 and the slider 62 in conformity to an inclination of the contact portions with the balls 61 provided on the outer periphery of the slider 62, which are bent upward.

(Disk Spring 64)

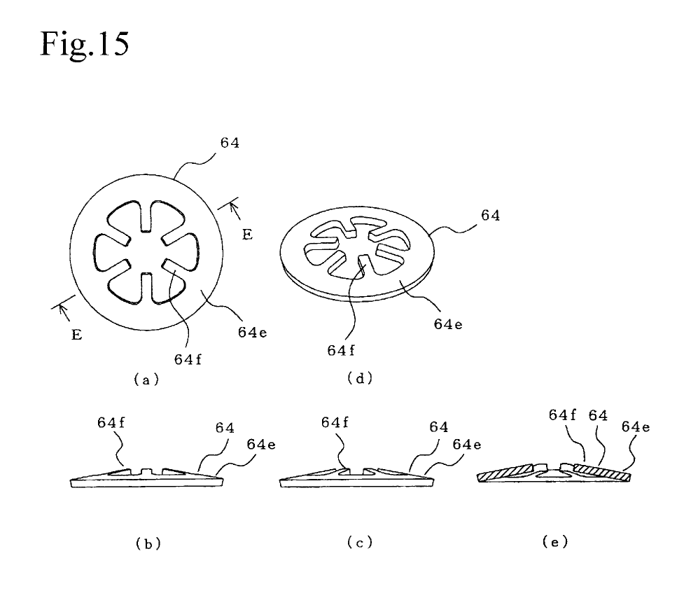

FIGS. 15(a) to (e) show a plan view, a front view, a right side view, a perspective view, and a cross-sectional view taken along the line E-E of the disk spring 64 in this embodiment.

The disk spring 64 includes an outer peripheral portion 64e and a projecting portions 64f projecting toward the center therefrom. The outer peripheral portion 64e functions to receive the load, and projecting portions 64f function as springs. The projecting portions 64f are each formed to have the same width (parallel) as illustrated, and the roots thereof are formed into an arcuate shape. The distance between the distal ends of the projecting portions 64f has the same length as the diameter of the through hole 64a in FIG. 9. Also, the disk spring 64 is formed so as to be increased toward the center, and is configured to be clamped between the washer A and the washer B (see FIG. 11). With this configuration, even when three pieces of the disk springs of the related art are needed, the same function can be obtained with a single piece of the disk spring 64 owing to the configuration of the disk spring 64 by itself and the application of a uniform force.

(Set Screw 65)

The head portion of the set screw 65 is stored in the depression 32 on the bottom surface of the valve body 30. In the first embodiment, the gap between the outer periphery of the head portion of the set screw 65 and the inner periphery of the depression 32 of the valve body 30 is minute. However, a large gap 32A is formed in this embodiment. In addition, an end surface of the head portion of the set screw 65 is formed into a spherical surface, and the bottom surface of the depression 32 and a spherical surface portion are in contact with each other.

Also, the disk spring 64 fitted on the head portion of the set screw 65 is arranged at an outer peripheral edge on the side of the valve body 30 and an inner peripheral edge on the side of the slider 62.

These configurations are just to allow the inclination of the set screw 65 in the interior of the depression 32. In other words, as shown in FIG. 16(b), when the ball holding mechanism 60 is operated in an inclined manner, since the head portion of the set screw 65 is a spherical surface portion, the frictional resistance with respect to the bottom surface of the depression 32 of the valve body 30 is reduced. Also, with the provision of the gap 32A between the head portion of the set screw 65 and the depression 32 of the valve body 30, the inclination of the set screw 65 in the interior of the depression 32 is achieved, and hence the set screw 65 can easily follow the inclination of the ball holding mechanism 60. Then, when the disk spring 64 is restored from the compressed state to a no-load state, the inclination of the ball holding mechanism 60 is absorbed and hence the inclination of the washer B is prevented. Accordingly, even when the set screw 65 is inclined, the closed state of the valve body 30 is maintained, and hence the valve body 30 is opened before the ball holding mechanism 60 is dropped off from the frame 20 thereby preventing water in the head body 10 from leaking from the water discharging cylinder 16.

Subsequently, the operation of the sprinkler head 1 in the second embodiment will be described. Since the basic operation is the same as the description in the first embodiment (paragraph 0045 to paragraph 0048), the operation on the basis of the configuration specific in the second embodiment will mainly be described. FIGS. 16(a) to (d) are drawings showing a process of operation of the sprinkler head 1.

(a) In the first embodiment, when the fire breaks out, the hot air hits on the thermosensitive plate 53 and heats up the same, and is spread to the thermosensitive member 55. In contrast, in this embodiment, the thermosensitive plate 71 and the thermosensitive plate cover 80 hit against the hot air and thus heated, so that the heat is propagated to the thermosensitive member 55.

Then, when the thermosensitive member 55 starts to melt, the melted thermosensitive member 55 flows out from a gap formed between the plunger 52 and the thermosensitive plate cover 80 and the volume thereof is reduced.

At this time, the balls 61 pressed from above by the balancer 63 the slider 62 receives a force to cause the same inward, and even when the balancer 63 is moved downward toward the thermosensitive cover 80 and the balls 61 are moved, the valve body 30 is brought into a press-contact with the valve seat 17, and a state of closing the water discharging port 12 is maintained. This occurs because of the action of the disk spring 64. The disk spring 64 is formed to be higher as it goes to the center, and is configured to be clamped between the washer A and the washer B, whereby the disk spring 64 has a stroke of a predetermined amount which can maintain the sealed state by the valve body 30. In this manner, the valve body 30 is prevented from coming apart from the valve seat 17 until the ball holding mechanism 60 is completely dropped, so that the reliable operation is ensured.

(b) When the thermosensitive member 55 is melted and flowed out to the outside, the thermosensitive plate cover 80 moves downward corresponding to the amount of outflow of the thermosensitive member 55. When the thermosensitive plate cover 80 is moved downward, the heat insulating member 54 and the balancer 63 mounted on the thermosensitive plate cover 80 are moved downward. When the balancer 63 is moved downward, the gap between the balancer 63 and the slider 62 is increased, so that the balls 61 urged inward move inward beyond the shoulder 63b of the balancer 63 to disengage the locking shoulder portion 22 of the frame 20 and the balls 61. Accordingly, the valve body 30 and the valve body supporting mechanism 50 move downward (FIG. 16(b)).

(c) When the valve body supporting mechanism 50 including the washer B, the disk springs 64, the washer A arranged below the valve body 30 drops, the valve body 30 moves downward. Also, in association with the downward movement of the valve body 30, the deflector 41 attached to the valve body 30, the guide rods 42 attached to the deflector 41, and the stopper ring 43 move downward (FIG. 16(c)).

(d) When the guide rods 42 move downward, the shoulder 42a provided on an upper portion thereof is locked with the stopper ring 43, and the stopper ring 43 is locked with the locking shoulder portion 22 of the frame 20, and the valve body 30 and the deflector 41 are brought into a state of being suspended from the frame 20 by the guide rods 42.

In this manner, when the valve body 30 is moved downward, the water discharging port 12 is opened, and the pressurized fire service water is sprinkled via the deflector 41 and extinguishes the fire (FIG. 16(d)).

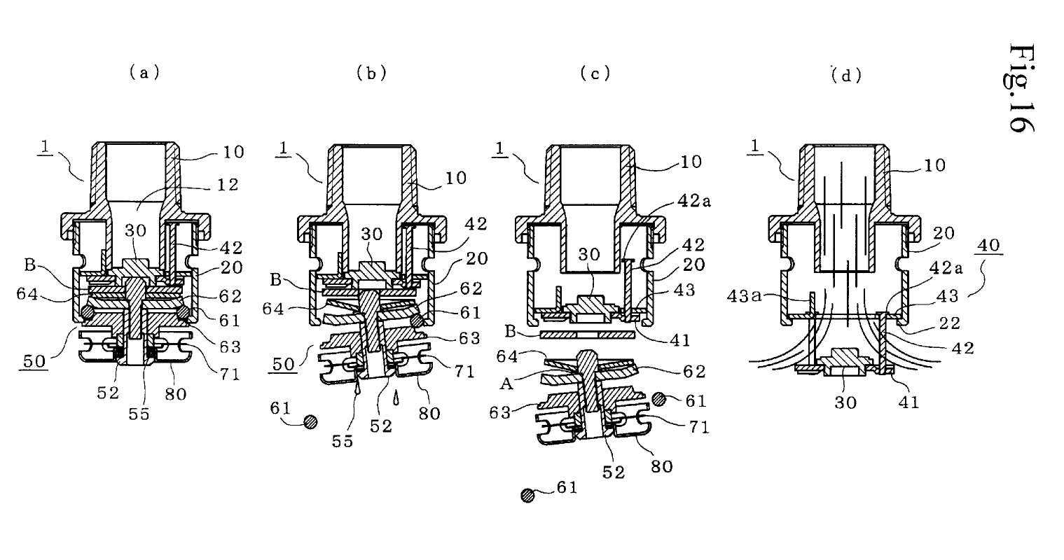

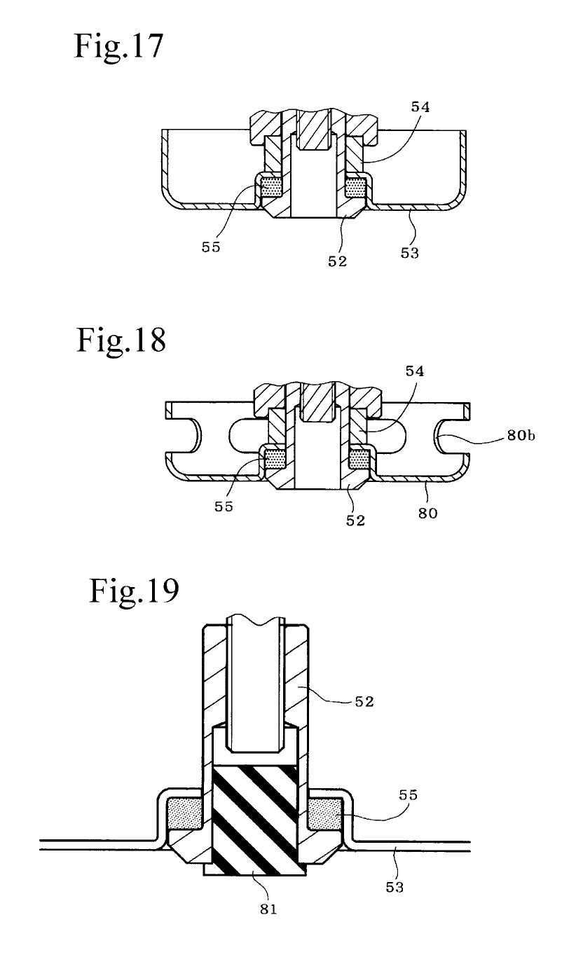

Modification of Embodiments [FIG. 17 to FIG. 19]

In the respective embodiments of the present invention, the embodiments are described with reference to the sprinkler head configured to support the valve body by the valve body supporting mechanism provided with the ball holding mechanism including the balls, the slider, and the balancer. However, the preset invention may be applied to a flash-type sprinkler head having a general-type piston which compress solder as a thermosensitive member, for example, a lever-type sprinkler head in which a pair of arms constitute the valve body supporting mechanism.

Also, although the valve body is brought into press-contact with the valve seat at a lower end of the water discharging cylinder, the valve body may be provided inside the water discharging cylinder.

For reference sake, although only the stopper ring is attached to the guide rods in a slidable state, the deflector may also be mounted so as to be slidable with respect to the guide rods.

An example in which the slit-shaped opening portion 80b is provided on the peripheral wall of the thermosensitive plate cover 80 in the second embodiment has been described, a configuration in which the opening portion 80b is not provided as shown in FIG. 17 is also applicable. Although the embodiment in which the thermosensitive plate 71 is not provided is shown in FIG. 17, the thermosensitive plate 71 may be provided.

Also, in the second embodiment, the embodiment in which the thermosensitive plate 71 is provided is shown. However, an embodiment having no thermosensitive plate 71 as shown in FIG. 18 is also applicable.

In the embodiment described above, the example in which the plunger 52 is formed with a hole, and the hole is opened toward the outside is shown. However, a heat insulating member 81 configured to close the hole may be provided as shown in FIG. 19. In this manner, by providing the heat insulating member 81 which closes the hole of the plunger 52, a thinned portion of the plunger 52 can be reinforced and, in addition, the heat insulating effect is ensured, so that the sensitivity performances can be secured.

Also, the heat insulating member 81 is installed so as to project from the end surface of the plunger 52. Therefore, when a substance hits from below, the probability of hitting against the heat insulating member 81 projecting most is increased, so that the probability of deformation of the plunger 52 or the thermosensitive plate 53 which affects the operation at the time of extinguishing the fire is minimized.

For reference sake, the heat insulating member 81 shown in FIG. 19 may be installed on the plunger 52 in the second embodiment. Also, the heat insulating member 81 may be formed of a hard material, for example, a hard resin.

### REFERENCE SIGNS LIST

1 sprinkler head, 10 head body, 11 opening portion, 12 water discharging port, 13 flange, 14, 15 screw portion, 16 water discharging cylinder, 17 valve seat, 18 space, 20 frame, 21 screw portion, 22 locking shoulder portion, 30 valve body, 31 flange portion, 32 depression, 40 sprinkling portion, 41 deflector, 1a insertion hole, 42 guide rod, 42a shoulder, 43 stopper ring, 43a guide member, 44 coil spring, 50 valve body supporting mechanism, 51 thermosensitive portion, 52 plunger, 52a flange portion, 52b female screw, 53 thermosensitive plate, 54 heat insulating member, 55 thermosensitive member, 60 ball holding mechanism, 61 ball, 62 slider, 62a depression, 63 balancer, 64 disk spring, 65 set screw, 71 thermosensitive plate, 80 thermosensitive plate cover, 81 heat insulating member

1-15. (canceled)

16. A sprinkler head comprising:
a cylindrical head body having a water discharging port;
a valve body configured to close the water discharging port;
a balancer which has a function to compress the thermosensitive member; and
a valve body supporting mechanism configured to support the valve body, the valve body supporting mechanism including a plunger having a flange portion at a lower portion thereof; a thermosensitive member provided on the flange portion of the plunger; and a thermosensitive plate provided in contact with the thermosensitive member, wherein
the balancer is formed with a hole for inserting a peripheral wall portion of the plunger,
the plunger is inserted into the balancer at an outer peripheral surface thereof and coupled with the set screw on an inner peripheral surface thereof at one end side of the peripheral wall portion thereof, and
an end of the plunger on the side of the thermosensitive plate protrudes with respect to the thermosensitive plate in the direction of an axial center of the head.

17. The sprinkler head according to claim 16, wherein the thermosensitive member includes a protruded portion configured to cover the thermosensitive member, and a disk portion formed by causing one end side of the projecting portion to project outward with respect to the axial center, and
the plunger has a shoulder or a tapered surface or an R surface at an outer peripheral edge of the flange portion projecting from thermosensitive plate, and the outer peripheral edge of the flange portion is arranged so as to be inscribed in the protruded portion of the thermosensitive plate via a gap.

18. The sprinkler head according to claim 17, wherein the thermosensitive plate is a thermosensitive plate cover having a side wall portion projecting toward the head body from an outer periphery of the disk portion of the thermosensitive plate.

19. The sprinkler head according to claim 18, wherein the side wall portion is provided with a hole.

20. The sprinkler head according to claim 19, comprising a disk member coming into contact with a bottom surface of the protruded portion of the thermosensitive plate, and the disk member is arranged at the same height as the hole of the side wall portion.

21. The sprinkler head according to claim 16, wherein the valve body supporting mechanism includes a set screw configured to couple with the plunger between the valve body and the plunger,
the plunger includes a peripheral wall portion having a hole in the interior thereof, and
the peripheral wall portion includes a thinned portion having a difference between the inner diameter and the outer diameter smaller than that of a joint portion with respect to the set screw is provided at a contact portion with respect to the thermosensitive member provided on the flange portion.

22. The sprinkler head according to claim 21 wherein a heat insulating member is arranged in the hole of the plunger.

23. The sprinkler head according to claim 22, wherein the heat insulating member has a projecting portion projecting from an end surface of the plunger.

24. The sprinkler head according to claim 16, further comprising:
a frame connected at one end to the head body and having at the other end a locking shoulder portion projecting inward, a ball configured to be locked with the locking shoulder portion, a slider configured to press the ball from the opposite side of the locking shoulder portion and support the valve body, and a balancer provided inside of the ball and configured to inhibit the movement of the ball, wherein
an outer peripheral edge of the slider is formed into an inwardly inclining tapered shape, and an inclined surface in a tapered shape is a contact surface with respect to the ball.

25. The sprinkler head according to claim 16, further comprising:
a frame connected at one end to the head body and having at the other end a locking shoulder portion projecting inward, a ball configured to be locked with the locking shoulder portion, a slider configured to press the ball from the opposite side of the locking shoulder portion and support the valve body, and a balancer provided inside of the ball and configured to inhibit the movement of the ball, wherein
the slider is formed with a contact surface for the ball on the outer peripheral edge of the slider, and a recessed portion for the ball formed with a depression inside the contact surface with respect to the balls.

26. The sprinkler head according to claim 16, wherein
the head body is formed with a water discharging cylinder having a water discharging port,
a frame connected at one end to the head body and having at the other end a locking shoulder portion protruding inward,
a sprinkling portion having a deflector, a guide rod configured to guide the movement of the deflector, and a stopper ring configured to stop the movement of the guide rod is further provided,
the stopper ring is provided with an insertion hole for the guide rod and the guide rod is formed with a shoulder for the stopper larger than the insertion hole, and
the stopper ring moves in the interior of the frame, comes into abutment with the locking shoulder portion and stops at the time of water discharging operation.

27. The sprinkler head according to claim 26, wherein the stopper ring is provided with a guide member which causes the stopper ring to move along the water discharging cylinder.

28. The sprinkler head according to claim 27, wherein the stopper ring is provided at substantially an intermediate position of the frame in the height direction, and
a coil spring configured to urge the stopper ring toward the locking shoulder portion of the frame between the stopper ring and the head body.

29. The sprinkler head according to claim 26, wherein the stopper ring is provided at substantially an intermediate position of the frame in the height direction, and
a coil spring configured to urge the stopper ring toward the locking shoulder portion of the frame between the stopper ring and the head body.

30. The sprinkler head according to claim 26, wherein the deflector is fixed to one end side of the guide rod, the head body is formed on the outside of the water discharging cylinder with an outer peripheral wall portion configured to be coupled with the frame, and the other end side of the guide rod fixed at one end side to the deflector is stored in a space formed between the water discharging cylinder and the outer peripheral wall portion.
